(19) United States
(12) Patent Application Publication
(10) Pub. No.: US 2003/0177610 A1
(43) Pub. Date: Sep. 25, 2003

(54) Dynamic handle for movement of loads

(76) Inventor: Joseph John Szyjakowski, Brown Deer, WI (US)

Correspondence Address: Joseph J. Szyjakowski, 8047 N. 53rd ST., Brown Deer, WI, 53223, US

(21) Appl. No.: 10/104,795

(22) Filed: Mar. 23, 2002

(51) Int. Cl. E05B 1/00

(52) U.S. Cl. 16/428

(57) ABSTRACT

A handle (10) to efficiently move a load by one or more persons with the use of a sled-type device (24), or by direct attachment to a load. The handle (10) is a solid unit constructed of plastic, wood, metal, or composite material with no other parts and needing only a rope, strap, or cable to function. The handle (10) converts from single to dual-pull configuration in only seconds and can be set up for tandem-pull in less than a minute. A notch-lip (20) in a rope-guide notch (18) securely holds the rope in place for the single pull set up. In addition, the handle (10) can be easily produced in various lengths and colors and is extremely durable.

### CROSS-REFERENCE TO RELATED APPLICATIONS

Not applicable.

### BACKGROUND FIELD OF INVENTION

This invention relates to moving a load by pulling, specifically a handle for efficiently moving a load by a person(s) or mechanical means.

### BACKGROUND DESCRIPTION OF PRIOR ART

Loads that were commonly moved on sleds or skidded along the ground were pulled with a rope by a person(s) or mechanical device.

Thereafter, inventors created several types of handles associated with a specific sled design for moving a load. U.S. Pat. No. 4,046,393 to Vadnais discloses a handle specific to the patents sled design and is made of welded metal or integrally molded plastic in a contorted shape with snap fasteners, rings, grommets, and lines with clasps.

Thus unless the various metal parts are made from expensive rustproofed metal or constantly serviced for rust prevention the longevity of the product will be short. Also, a breakdown in the field of any of the many parts would mean replacement parts would need to be carried or extensive modification done in the field to prevent a total system failure.

The Duerst U.S. Pat. No. 3,771,808 discloses a rope secured to reinforced apertures in the forward margin is used to drag the skid. There is no rigid handhold and the rope can easily twist or uncomfortably tighten around the hand or fingers.

The Sap U.S. Pat. No. 3,547,456 discloses a game-transporting device with two adjustable looped straps and two fixed handhold straps permanently affixed to the device with no rigid connecting system between straps or handholds.

### SUMMARY

In accordance with the present invention a solid one-piece handle with holes, notches, and handgrips to efficiently move a load on or off a sled-type device by one or more people or by attachment to a mechanical device such as a winch, all-terrain vehicle, snowmobile as well as coaster-wagons.

### OBJECTS AND ADVANTAGES

Accordingly, besides the objects and the advantages of the handle described in my above patent, several objects and advantages of the present invention are:

(a) to provide a handle which is a solid, rigid one-piece device with no additional parts and needing only a rope, flex-cable or strap to work;

(b) to provide a handle which has superior strength, durability, and product longevity;

(c) to provide a handle which allows one, two, or more people to efficiently move a load, on a sled-type device or skidded on the ground, with a great deal less effort than pulling on a rope.

Further objects and advantages are to provide a handle that is low cost and easily produced in plastic, wood, metal, or composites in various colors and sizes which is extremely durable, lightweight, service-free, and safe to use, and which eliminates the problems associated with the single-person pull such as caused by the rope twisting and tightening around the hand and digits, as well as the problems commonly associated with dual-person pulling such as constantly bumping into each other and the tendency to pull away from each other or pulling at an angle to the load rather than straight away from the load. Still further objects and advantages will become apparent from a consideration of the ensuing description and drawings.

### DRAWING FIGURES

For a further understanding of the nature and objects of the present invention, reference should be had to the following detailed description, taken in conjunction with the accompanying drawings, in which like elements are given the same or analogous reference numbers and wherein:

FIG. 1 is a perspective view of the present invention.

FIG. 2 is a one-dimensional view of one end of the handle showing the contoured handhold, and the slotted rope-guide with the notch-lip.

FIG. 3 is a perspective view of the rope position on the handle for the one-person pull of a sled-type device.

FIG. 4 is a perspective view of the rope position on the handle for the two-person pull of a sled-type device.

### REFERENCE NUMERALS IN DRAWINGS

| | | | |
|---|---|---|---|
| 10 | handle | 12 | rope-guide hole |
| 14 | tandem-pull rope-guide hole | 16 | contoured handhold |
| 18 | rope-guide notch | 20 | notch-lip |
| 22 | rope | 24 | sled-type device |

### DESCRIPTION OF THE PREFERRED EMBODIMENT

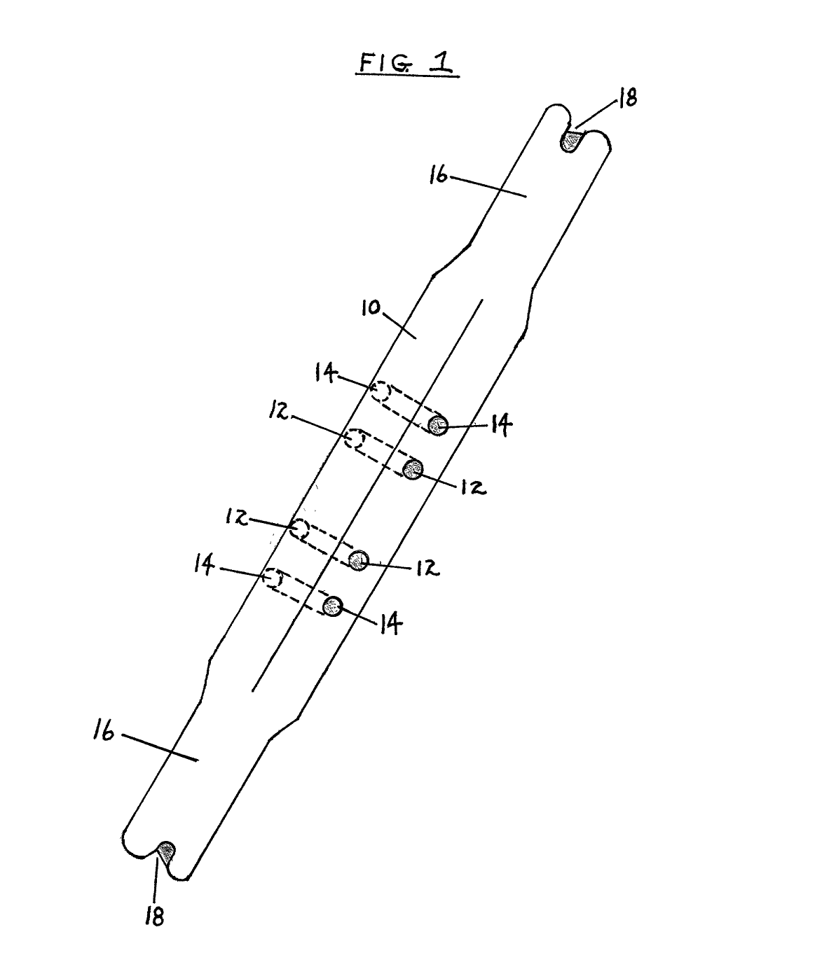

A preferred embodiment of the handle of the present invention is illustrated in FIG. 1. A handle body 10 that is typically 26 inches to 36 inches long with a rectangular shape that is roughly 1 inch to 2 inches thick. A contoured handhold 16 that is approximately 6 inches in from each end of the handle body 10. The handle body 10 is comprised of rigid polyvinyl chloride material. However, the handle can consist of any other material that can hold the required shape and remain rigid without fracturing such as metal, wood, various plasticized material, composites, etc.

Typically, 3 inches to 4 inches both left and right from the center-point of the handle body 10 is a rope-guide hole 12. The rope-guide holes 12 will vary in size from 9/32 inch to ¾ inch in diameter depending on the size of the rope, cable, or strap going through the rope-guide hole 12. Moving out 3 inches towards the contoured handholds 16 from the rope-guide holes 12 one finds a tandem-pull rope-guide hole 14 that is 9/32 inch to ¾ inch in diameter. At both ends of the handle body 10 is a rope-guide notch 18 that is typically one-half the size of the rope-guide hole 12. The rope-guide hole 12 as well as the tandem-pull rope-guide hole 14 and the rope-guide notch 18 are all centered and drilled parallel through the handle body 10.

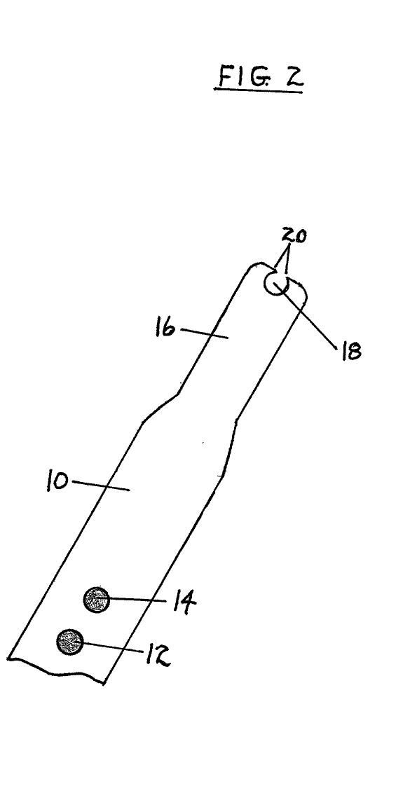

In FIG. 2 the contoured handhold 16, that is approximately 6 inches long, and the rope-guide notch 18 are shown. The rope-guide notch 18 is drilled parallel to, and ⅗ the diameter of the rope-guide hole 12 leaving a notch-lip 20.

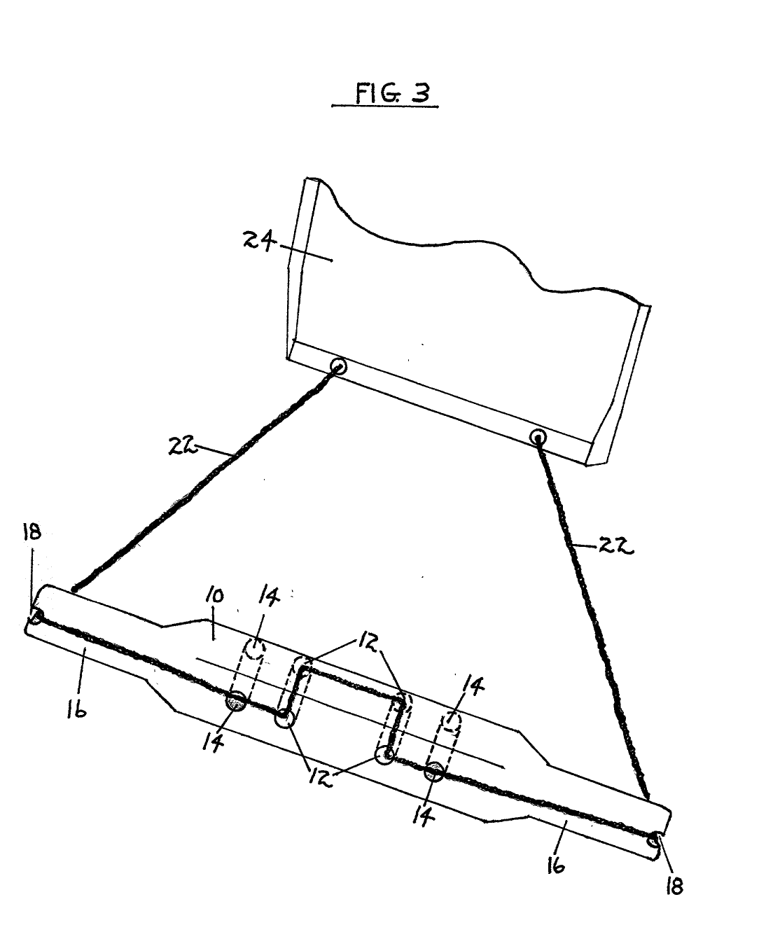

In FIG. 3 the handle 10 is set up for a one-person pull showing a rope 22 attached to a sled-type device 24 with the rope 22 configured through the rope-guide holes 12 and traveling left and right and being secured in the rope-guide notch 18 by the notch-lip 20 when the rope 22 is equal in distance from the sled-type device 24 to the rope-guide notches 18.

The puller can now position between the ropes 22, and the sled-type device 24, and begin pulling with the handle 10 positioned along the waist or with a quick adjustment in the rope 22 length between the sled-type device 24 and the rope-guide notch 18 by 12 inches to 24 inches the handle 10 can be positioned from shoulder to opposite hip across the front of the chest allowing a hands-free pull.

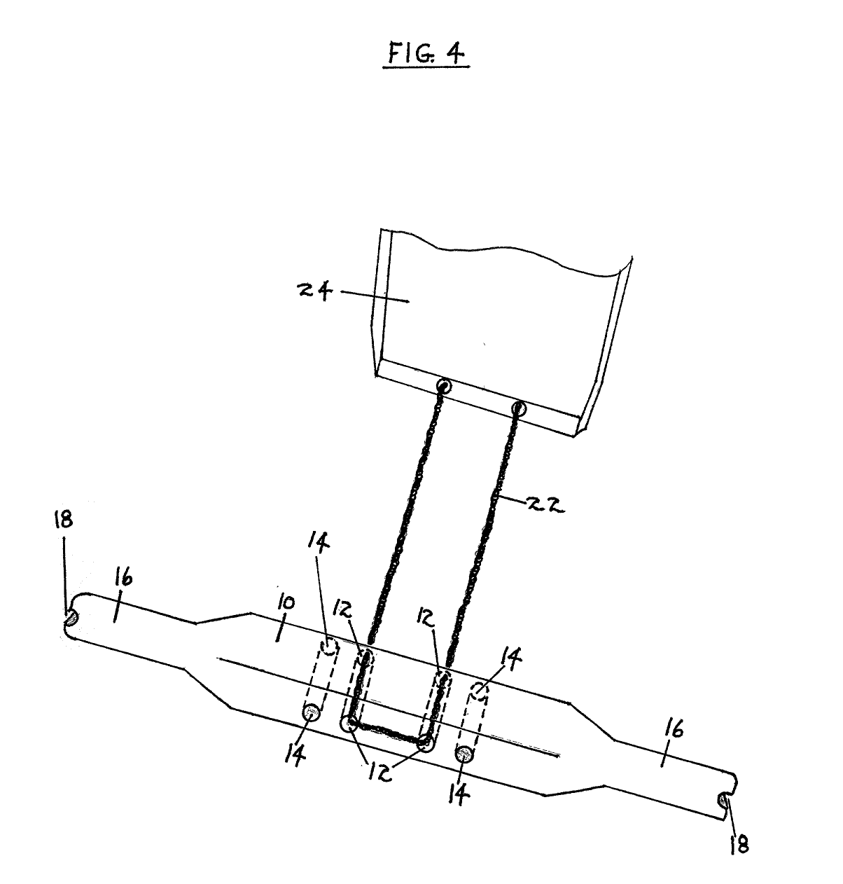

In FIG. 4 the handle 10 and the rope 22 are in position for the two-person pull with the ropes 22 configured through the rope-guide holes 12 so the ropes 22 are equal distance from the sled-type device 24 to the rope-guide holes 12. Persons pulling simply grab a contoured handhold 16 and easily pull the load. When the handle 10 is in the two-person pull position a tandem-pull condition can be achieved by quickly and easily attaching a second handle with ropes to the first handle by passing the ends of the ropes of the second handle through a tandem-pull rope-guide hole 14 of the first handle and securing the rope with a knot in the end of the ropes that is larger than the circumference of the tandem-pull rope-guide hole 14. This configuration allows for a 3 or 4 person pull simply by using the second handle set-up as seen in FIG. 3 for a 3-person or FIG. 4 for a 4-person pull. The tandem-pull connections are infinite.

### CONCLUSION, RAMIFICATIONS, AND SCOPE

Accordingly, the reader will see the handle of the invention provides a highly reliable, physically energy saving, easily adjustable, and economical device that can be used by persons of almost any age. While my above description contains many specifications, these should not be construed as limitations on the scope of the invention, but rather as an exemplification of one preferred embodiment thereof. Many other variations are possible. For example, the overall length of the handle can vary; the contour of the handhold can have other shapes, such as square, oval, cross-hatched, triangular, ect; the color of the handle as well as a print pattern, such as camouflage, can encompass the entire color spectrum; the material the handle is made from can include metal, wood, composites, and any variations of plastic products available; the handle can be attached to a sled-type device by knotting the rope ends after being passed through a hole in the sled-type device or tied directly to a ring, another piece of a rope, or tied directly to a load with ropes; the load being pulled can be pulled with the aid of a mechanical device by attaching the handle to a snowmobile, ATV, winch, etc.

Thus the scope of the invention should be determined by the appended claims and their legal equivalents, rather than by the examples given.

I claim:

1. A handle comprising a rectangular bar forming a body, including a contoured handhold on both ends of said body, with a means to secure a rope via a rope-guide hole or a rope-guide notch in said body.

2. The handle of claim 1 wherein said body has predetermined and parallel said rope-guide holes and said rope-guide notches that pass through said body providing a means for said rope to route through.

3. The handle of claim 1 wherein the said contoured handhold includes said rope-guide notch, located in the ends of the said handle body with a notch-lip that provides a means to secure said rope.

4. The handle of claim 1 wherein the attachment means to a sled-type device or directly to a load is realized by knotting the ends of said rope after passing through a tow-rope hole in said sled-type device or by tying said rope directly to the load.
